(19) United States
(12) Patent Application Publication
(10) Pub. No.: US 2007/0090575 A1
(43) Pub. Date: Apr. 26, 2007

(54) Method of polymerizing colored patterns inside a mode

(76) Inventor: Fu-Chen Chen, Taichung County (TW)

Correspondence Address: Fu-Chen Chen, P.O. Box 96-556, Taipei, 10668, TW

(21) Appl. No.: 11/258,060

(22) Filed: Oct. 26, 2005

(51) Int. Cl. B29C 51/10; B29C 45/14

(52) U.S. Cl. 264/511; 264/553; 264/278; 264/161; 264/259

(57) ABSTRACT

This invention presented is a method of polymerizing colored patterns inside a mode, comprising a top pattern, a middle pattern and a bottom pattern, enabling a meltable object to be infused into the mode for forming the mold shape. The bottom pattern enables a thermal-transfer film to be put thereon, and then the middle pattern keeps down the perimeter of the thermal-transfer film for fixing the film and forming a vacuity, thereby the thermal-transfer film is able to completely contact the cavity inside the bottom pattern; subsequently, a meltable object is infused into the mold after the mold is closed. Seeing that the thermal-transfer film is a thermoplastic polymer having a similar property to the meltable object, therefore, the thermal-transfer film is able to be directly printed on the meltable object surface by way of the hot temperature of the meltable object. The transfer printing process is then finished after the meltable object inside the mold is shaped. Therefore, the invention possesses the characteristics of simultaneously shaping and transfer printing without an additional increase in temperature on the thermal-transfer film, moreover, the invention is more applicable to objects with cambered surfaces and/or large areas.

### BACKGROUND OF THE INVENTION

(1) Field of the Invention

This invention relates to colored pattern printing, in particular, to a method of polymerizing colored patterns inside a mode that enables a melted substance (formed composite body) to go through the steps of painting, printing, color drawing and polish lacquer spraying during the forming process at one time without another step of thermal transfer printing required.

(2) Description of the Prior Art

The thermal transfer printing technique has been considerably applied to various articles; nowadays, it is easy to apply the thermal transfer printing to an output of an image on a transfer paper (a pattern is presently outputted on a transfer paper by thermal sublimation or color laser printing after computerized typesetting). Nevertheless, a prerequisite condition for applying the thermal transfer printing is that an article is required to be ready for a transfer paper to print a selected pattern thereon by the methods of pressurizing and preheating. A transfer paper is used for printing different patterns on various materials according to appropriate temperature and pressure. It is quite a simple way to apply partial thermal transfer printing on an article, however, it is not easy while applying the thermal transfer printing on a large-area or cambered surface of an article evenly without falling off. Therefore, the thermal transfer printing interface is crucial to the transfer paper manufacturing technique, i.e., the transfer printing can not be done as either lower temperature makes a pattern unable to be adhered on an article, or higher temperature makes the smudging or smearing effect of a pattern. Consequently, the temperature and pressure in the heating system of the thermal transfer printing and the diverse thickness problems concern the thermal transfer printing quality.

At present, the thermal transfer printing technique has been applied on diversified articles, such as shoesoles, PU compounds, PU decorative stripes, bicycle seat, ABS plate press or EVA products and PU shoe outsoles. The invention mainly applies a layer of viscose to a shoes outsole, subsequently, vacually pastes the shoes outsole with a thermal-transfer film, enabling the thermal-transfer film to be adhered to a shoe outsole by drying and pressurizing, and then trims unnessary thermal-transfer film on the edge thereof; the transfer printing process is then finished.

Seeing that the perimeter of a shoesole has a variety of cambered surfaces with a lot of rough grains or lines in surface, it is difficult to make a transfer paper completely adhere to the shoesole without falling off therefrom; in addition, the processing is complicated, making the temperature, increasing pressure, printing surface and the transfer paper quality concern the printing quality. Nevertheless, conventional thermal transfer printing is hard to be applied to a large-area surface, resulting in some problems over cambered (rippled and uneven) surfaces with repeated processing required; namely, such a printing technique is unable to solve the problem between printing and color drawing during the shoesole forming process.

Therefore, to solve the afore-mentioned problems, the inventor applies the principle of conventional manufacturing with many years of experience in the industry to develop said method of polymerizing colored patterns inside a mode with more practical application for use.

### SUMMARY OF THE INVENTION

The main objective of the method of polymerizing colored patterns inside a mode according to the invention is to enable a meltable substance (formed composite body) to go through the color drawing steps during the forming process at one time without thermal transfer printing required. In addition, the invention enables no extra temperature or pressure to be applied to large-area formed composite bodies with cambered surfaces.

The present invention mainly comprises a mold allowing a meltable object to be formed into a shape of the chamber therein; the mold is divided into a bottom pattern, a middle pattern and a top pattern, wherein the bottom pattern forms a cavity therein, the middle pattern comprises a hollow portion having a shape similar to said cavity, and the top pattern comprises a plurality of raised objects, which are able to be contained inside the hollow portion of the middle pattern and the cavity of the bottom pattern. Said cavity of the bottom pattern comprises a plurality of air holes inside thereof connecting a ventiator and externally connecting an inhalant ventiator, the bottom pattern has a plurality of fastener components set on one side thereof for respectively positioning the middle pattern and the top pattern. The method of polymerizing colored patterns is described as follows:

a. placing a thermal-transfer film, which is a thermoplastic polymer, on top of the bottom pattern;

b. pressing down the middle pattern over the bottom pattern and hooking the middle pattern by one of said fastener components, enabling the middle pattern to keep down over the perimeter of the thermal-transfer film;

c. opening the inhalant ventiator, activating the air holes inside the bottom pattern for air induction, allowing the thermal-transfer film to be adhered to the cavity inside the bottom pattern and forming the vacuity state;

d. enabling the top pattern to lay over the middle pattern and hooking the top pattern by the other fastener component;

e. filling up the mold with said meltable object inside thereof;

f. awaiting the meltable object forming into the mold shape, pulling open the two fastener components, respectively opening the top pattern and the middle pattern, and retrieving the shape-formed object and the thermal-transfer film;

g. printing the thermal-transfer film on the bottom side of the shape-formed object owing to the temperature of the meltable object appropriate for the printing, and then trimming unnessary thermal-transfer film on the edge thereof; the transfer printing process is then finished.

Accordingly, the property of said thermal-transfer film is similar to that of the meltable object, and the meltable object is hot enough to directly go through the printing process, so as to complete the shape forming of the meltable object and the printing process at the same time without repeating processing or additionally increasing temperature required; therefore, the invention enables to achieve the objectives of evenly printing on a large-area cambered surface and improving the printing quality.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is an exploded three-dimensional view of the invention;

FIG. 2 is a cross-sectional view showing a state of placing a thermal-transfer film into a bottom pattern of the invention;

FIG. 3 is a cross-sectional view showing the vacuity state between the thermal-transfer film and a cavity according to the invention;

FIG. 4 is a three-dimensional view showing the vacuity state between the thermal-transfer film and the cavity of the invention;

FIG. 5 is a cross-sectional view of a closed mold with a formed composite body infused inside thereof according to this invention; and

FIG. 6 is a cutaway view showing a formed composite body of this invention after transfer printing.

### DESCRIPTION OF THE PREFERRED EMBODIMENTS

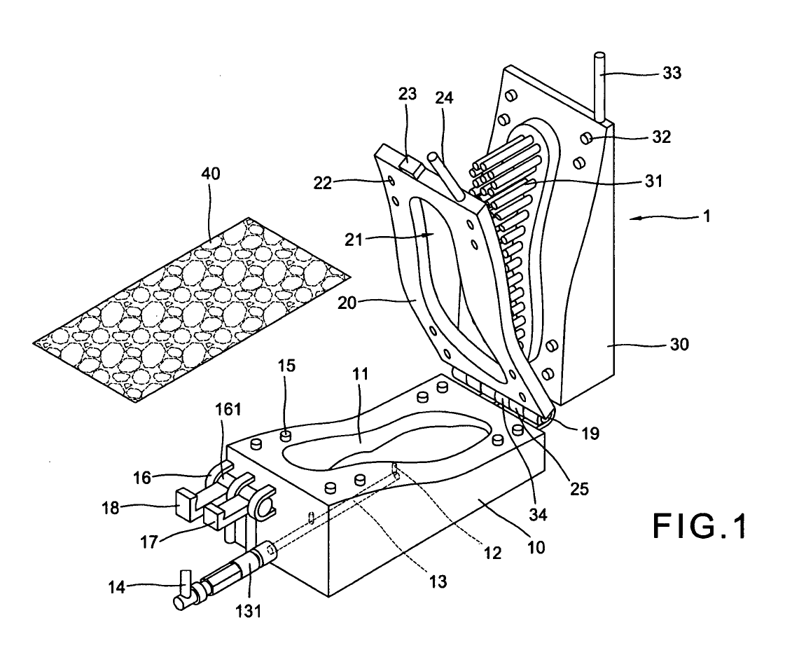

With reference to FIG. 1, the invention comprises a mold 1, which is composed of a bottom pattern 10, a middle pattern 20 and a top pattern 30. A cavity 11 is formed inside the bottom pattern 10 thereof with lines and two air holes 12 formed on inner part; the air holes 12 link with a ventiator 13 embedd in the bottom pattern 10; the ventiator 13 externally connects an inhalant ventiator 14 through a joint 131; the inhalant ventiator 14 is activated for air induction via a motive air pressure mechanism; the bottom pattern 10 has a plurality of raised units 15 set on the surface thereof and has a plurality of hooks 16 on the rear side thereof for pivoting a pole 161, which connects two fastener components 17 and 18; the middle pattern 20 comprises a hollow portion 21 corresponding to the cavity 11 of the bottom pattern 10, in addition, the middle pattern 20 has a plurality of holes 22 set thereon in opposition to the plurality of raised units 15 of the bottom pattern 10; the middle pattern 20 has a nose 23 and a handle 24 set on the rear side thereof; the top pattern 30 comprises a plurality of raised objects 31 and a plurality of raised units 32 thereon, wherein the raised objects 31 are positioned within the areas of the cavity 11 and of the hollow portion 21, the raised units 32 are correspondent with the plurality of holes 22 of the middle pattern 20; moreover, the top pattern 30 has a handle 33 set on the rear side thereof; the respective front sides of the bottom pattern 10, the middle pattern 20 and the top pattern 30 are pivoted together by a rod 19 and pluralities of hooks 25 and 34.

The forming of the invention is described as follows:

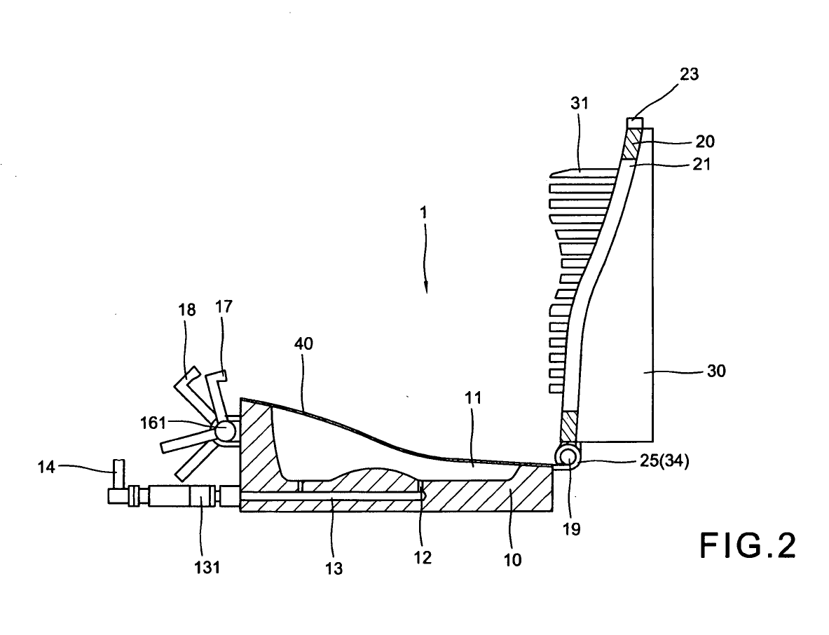

a. as shown in FIGS. 1 and 2, a color drawing is placed over a thermal-transfer film 40 on top of the bottom pattern 10 (the printing ink side of the thermal-transfer film 40 faces upwards), the thermal-transfer film 40 is a Thermoplastic Polyurethane (TPU) polymer having the properties thereof similar to a PU compound (formed composite body), so that such a PU compound is able to be integrated with the thermal-transfer film 40;

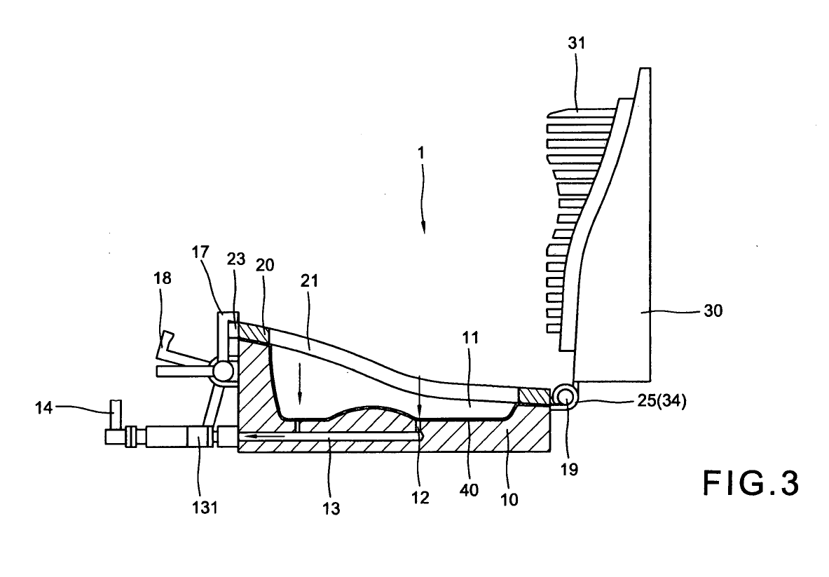

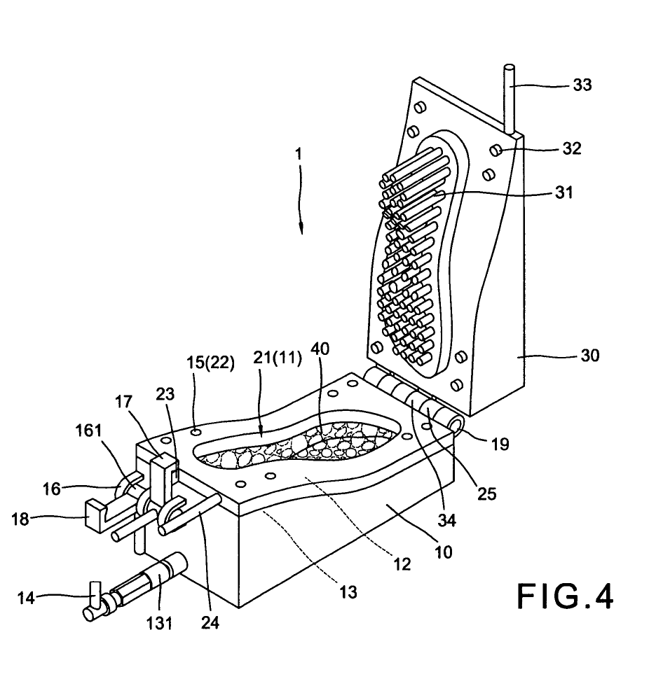

b. as shown in FIGS. 3 and 4, the middle pattern 20 is placed over the bottom pattern 10 and wedged with the plurality of holes 22 of the middle pattern 20 and the plurality of raised units 15 of the bottom pattern 10, in addition, the perimeter of the thermal-transfer film 40 is kept down and fixed, the nose 23 of the middle pattern 20 is hooked by the fastener component 17;

c. the plurality of air holes 12 are activated for air induction by a motive air pressure mechanism, allowing the thermal-transfer film 40 to be closely adhered to the cavity 11 inside the bottom pattern 10 forming the vacuity between the thermal-transfer film 40 and the cavity 11;

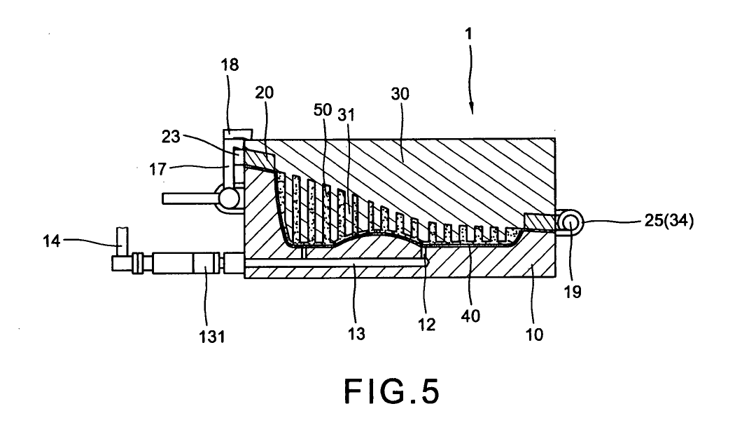

d. as shown in FIG. 5, the top pattern 30 is laid over the middle pattern 20, so that the raised objects 31 are placed inside the hollow portion 21 of the middle pattern 20 and the cavity 11 of the bottom pattern 10, the raised units 32 of the top pattern 30 are embedded into the plurality of holes 22 on the middle pattern 20, the perimeter of the top pattern 30 is then fixed by the fastener component 18;

e. a meltable object (formed composite body ) is infused into the bottom pattern 10 (not shown) of the mold 1 in full, [or such a meltable object (formed composite body ) is infused into the mold 1 before the closing of the top pattern 30].

f. the top pattern 30 and the middle pattern 20 are opened by pulling the fastener components 17 and 18 after said meltable object (formed composite body ) is shaped inside the mold 1, and the formed composite body is then retrieved out, at this time, the thermal-transfer film has been printed on the bottom of the formed composite body;

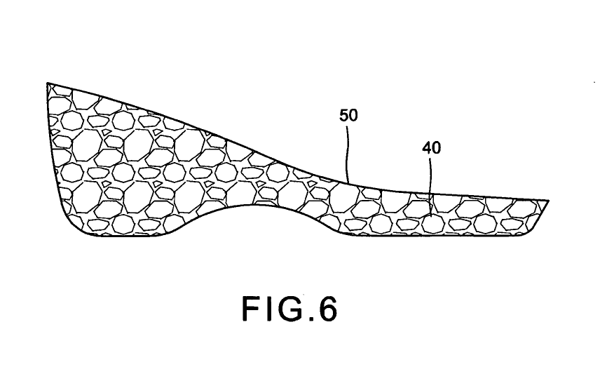

g. unnessary edges of the thermal-transfer film 40 on the formed composite body (shoesole) 50 are then trimmed, and the transfer printing process is then finished (as shown in FIG. 6).

In view of the foregoing, the property of thermal-transfer film 40 according to the invention is a Thermoplastische PURElastomere (ppu), similar to the property of the formed composite body (shaped object). When the melted formed composite body is infused into the mold 1, directly polymerizing the thermal-transfer film 40 with the formed composite body by way of the temperature of the formed composite body; consequently, no additionally heating of the thermal-transfer film 40 is required, i.e., when the formed composite body is shaped, the transfer printing is simultaneously completed. Therefore, the invention differs from conventional thermal transfer printing technique that requires a shaped composite body to be pressed by a thermal-transfer film for printing. A conventionally formed composite body possesses certain of hardness on the surface, so that such a formed composite body, especially with a cambered surface or a large area, is unable to be evenly printed.

On the contrary, the invention avoids the above problem enabling a meltable formed composite body to directly connect the thermal-transfer film 40, so that either a cambered surface, an oblique angle or a large area is able to directly contact the surface of the thermal-transfer film 40 as long as the meltable formed composite body is not shaped yet; consequently, the transfer printing effect is with high printing quality, lower fault rate, in addition, the color drawing on the surface of the formed composite body after transfer printing does not fall off on the surface, as well as is long-wearing, scratch-resistant, mold-resistant and germproof. Moreover, the thermal-transfer film 40 is made from an environmental protection material, therefore, even when a pair of shoes (a formed composite body) is discarded or dieused, the thermal-transfer film 40 is discomposed naturally due to humidity, thereby no environmental pollution problem is caused;

In addition to a shoesole, the invention is able to be applied to the transfer printing on a variety of products, such as PU decorative stripes, bicycle seats, ABS plate press, EVA or PVC materials. Furthermore, the invention is able to be applied to the processes of painting, printing, color drawing and polish lacquer spraying at one time to largely increase the printing quality in shorter processing time, not to mention a great quantity of mass production with higher competitiveness in the industry.

Therefore, the method of polymerizing colored patterns inside a mode of the invention is designed to promote the practicability in the industry. New characteristics and advantages of the invention covered by this document have been set forth in the foregoing description. It is to be expressly understood. however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course. defined in the language in which the appended claims are expressed.

What is claimed is:

1. A method of polymerizing colored patterns inside a mode, comprising:
a mold, enabling a meltable object to be infused therein for shape forming; the mold is composed of a bottom pattern, a middle pattern and a top pattern; the bottom pattern comprises a cavity therein, the middle pattern comprises a hollow portion therein corresponding to the shape of the cavity, and the top pattern comprises a plurality of raised objects to be contained in the hollow portion of the middle pattern and the cavity of the bottom pattern; the cavity of the bottom pattern comprises a plurality of air holes inside thereof connecting a ventiator and externally connecting an inhalant ventilator; the bottom pattern has one end thereof set fastener components to respectively hook and position the middle pattern and the top pattern; the method of polymerizing color drawing comprising:
a. placing a thermal-transfer film, which is a thermoplastic polymer, on top of the bottom pattern;
b. pressing down the middle pattern over the bottom pattern and hooking the middle pattern by one of said fastener components, enabling the middle pattern to keep down over the perimeter of the thermal-transfer film;
c. opening the inhalant ventiator, activating the air holes inside the bottom pattern for air induction, allowing the thermal-transfer film to be adhered to the cavity inside the bottom pattern and forming the vacuity state;
d. enabling the top pattern to lay over the middle pattern and hooking the top pattern by the other fastener component;
e. filling up the mold with said meltable object inside thereof;
f. awaiting the meltable object forming into the mold shape, pulling open the two fastener components, respectively opening the top pattern and the middle pattern, and retrieving the shape-formed object and the thermal-transfer film;
g. printing the thermal-transfer film on the bottom side of the shape-formed object owing to the temperature of the meltable object appropriate for the printing, and then trimming unnessary thermal-transfer film on the edge thereof; the transfer printing process is then finished;
Accordingly, the property of said thermal-transfer film is similar to that of the meltable object, and the meltable object is hot enough to directly go through the printing process, so as to complete the shape forming of the meltable object and the printing process at the same time without repeating processing or additionally increasing temperature required; therefore, the invention enables to achieve the objectives of evenly printing on a large-area cambered surface and improving the printing quality.

2. The method of polymerizing colored patterns inside a mode of claim 1, wherein the thermal-transfer film is a polymer made of Thermoplastic Polyurethane (TPU), having the properties similar to a PU formed composite body.

3. The method of polymerizing colored patterns inside a mode of claim 1, wherein the bottom pattern has a plurality of raised units set on the surface thereof; correspondingly, the middle pattern comprises a plurality of holes set thereon; correspondingly, the top pattern comprises a plurality of raised units, thereby when the top, the middle and the bottom patterns are closed, the raised units of the bottom pattern and the raised units of the top pattern are respectively embedded into the holes inside the middle pattern.

4. The method of polymerizing colored patterns inside a mode of claim 1, wherein the respective front sides of the top, the middle and the bottom patterns are pivoted together; the bottom pattern set a rod to pivot respective hooks of the middle pattern and the top pattern.

5. The method of polymerizing colored patterns inside a mode of claim 1, wherein the bottom pattern sets a pole with the two fastener components; the bottom pattern additionally sets a plurality of hooks to pivot the pole, thereby enabling the two fastener components to revolve; the middle pattern has a nose for the fastener components to hook up together.
